(19) United States
(12) Patent Application Publication
(10) Pub. No.: US 2006/0161782 A1
(43) Pub. Date: Jul. 20, 2006

(54) System and method for management of the production of printed material

(76) Inventor: Peter Kassan, Hudson, NY (US)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(21) Appl. No.: 11/283,894

(22) Filed: Nov. 22, 2005

Related U.S. Application Data
(63) Continuation-in-part of application No. 11/204,059, filed on Aug. 15, 2005.
Application No. 11/204,059 is a continuation-in-part of application No. 11/199,358, filed on Aug. 8, 2005.
Application No. 11/199,358 is a continuation-in-part of application No. 11/193,716, filed on Jul. 29, 2005.
Application No. 11/193,716 is a continuation of application No. 10/671,194, filed on Sep. 25, 2003.
(60) Provisional application No. 60/592,489, filed on Jul. 30, 2004.
(60) Provisional application No. 60/604,119, filed on Aug. 24, 2004.
(60) Provisional application No. 60/630,155, filed on Nov. 22, 2004.
(60) Provisional application No. 60/601,532, filed on Aug. 13, 2004.
(60) Provisional application No. 60/599,519, filed on Aug. 6, 2004.
(60) Provisional application No. 60/637,652, filed on Dec. 20, 2004.
(60) Provisional application No. 60/630,013, filed on Nov. 22, 2004.
(60) Provisional application No. 60/598,985, filed on Aug. 5, 2004.

(51) Int. Cl. H04L 9/00

(52) U.S. Cl. 713/176

(57) ABSTRACT

A system and method for automatically or semi-automatically controlling the printing of materials that consume expensive expendable resources. A software program is installed on an individual's personal computer or workstation, on any computer on a network, on a printer server, or on the computer controlling a printer. The software program intercepts print requests directed to the individual's personal printer, to any printer attached to the network, to the printer controlled by the particular computer, or to any set of user-specified printers. Based on default or user-specifiable criteria, the software program evaluates the file representing the document to be printed and determines whether the document is allowed to be printed by the originally intended printer or whether it is redirected to another printer, a central site or cancelled.

### CROSS REFERENCE TO RELATED APPLICATIONS

The present invention is based on and claims priority to U.S. patent application Ser. No. 11/204,059, filed Aug. 15, 2005, entitled SYSTEM AND METHOD FOR MANAGING COPYRIGHT INFORMATION OF ELECTRONIC CONTENT which is a continuation in part of U.S. patent application Ser. No. 11/199,358 filed Aug. 8, 2005, entitled SYSTEM AND METHOD FOR VIRTUAL PRINT DEVICES FOR COMMAND IMPLEMENTATION, which is a continuation-in-part of U.S. patent application Ser. No. 11/193,716 filed Jul. 29, 2005, entitled IMPROVED SYSTEM AND METHOD FOR PROVIDING FORMATTED PRINT PAGES, which is a continuation-in-part of Ser. No. 10/671,194 filed Sep. 25, 2003, entitled SYSTEM FOR PRODUCING ONLINE CONTENT FROM WEB SITES ON DEMAND, the entire contents of all of which are hereby incorporated herein by reference

### FIELD OF THE INVENTION

The present invention relates generally to printing of information and, more particularly, to the controlled printing of information by an organization.

### BACKGROUND OF THE INVENTION

Many sites on the World Wide Web of the Internet (hereinafter, “web sites”) are magazine-like in format, or present a number of magazine-like sections. In many cases, the site, or specific magazine-like section, is often formatted in columns and/or rows of simulated or virtual “pages” and includes photographs or pieces of art. These specifically formatted elements of these web pages are meant to be viewed as a whole. With respect to photographs, small “thumbnail” images are typically provided that cause larger, more viewable images to be displayed, when selected via a click of a mouse or other pointing device. In other cases, web sites are not magazine-like at all, and consist entirely of text.

It is well-established that people prefer to read documents on physical paper rather than on a computer display (see, for example, The Myth of the Paperless Office, by Abigail J. Sellen and Richard H. R. Harper [MIT Press, 2001]). It is also well-established that people like to view, collect and own art, graphics, and photography on paper or similar medium, such as books and magazines. Printing web site “pages” that comprise art, graphics, and photography, for example, on a user's home printer or even lower speed, lower cost corporate network printers, usually yields unsatisfactory results despite a similarity between “pages” on Internet web sites and physical pages in a book or magazine. Even text-based web sites that are printed on a home printer or lower cost corporate printer are typically, unsatisfactory as people prefer printed text in, for example, a bound volume.

A typical cause for such unsatisfactory results is that web pages are usually not formatted to be reproduced on standard-sized printer pages, e.g., 8½ by 11 inch paper. For example, printed web sites frequently run onto subsequent, partially filled pages. Other problems include partial or incomplete printing, and printing of undesired content, such as programming code or coded representations of objects. Internet web sites rarely, if ever, resize oversized images for a user's printing, so that the images typically print on successive pages or are truncated. Although a skilled user can often find a way to format a printed web page properly (such as by printing only a selected “frame”, printing only selected material, or sizing an image to fit the paper), most users do not know how to do so, or find it too much trouble to do so, particularly for large numbers of pages. Moreover, navigation links and other material that is often included at the bottom of each web page are typically repeated at the end of each section when it is physically printed.

Furthermore, many printing devices do not accommodate double-sided printing. Although some printing devices have double-sided capability, users often forget or don't know how to set their printing device to do so. Some printing devices, for example many kinds of laser printers, also do not print in color, although the majority of web sites use color. Further, optimal results for art, graphics, and photography web pages are only achieved by using special, expensive paper. Moreover, photo-quality paper is rarely distributed with a double-sided capacity.

Even if a user has the appropriate printing device, paper, and skills to format and print web pages such that they are well laid-out on both sides of a set of pages of appropriate quality, the print jobs are typically output on unbound single sheets of paper and are also, therefore, unsatisfactory.

Some web sites provide portions of content that are available in the PORTABLE DOCUMENT FORMAT (“PDF”), as developed by ADOBE SYSTEMS. The PDF versions can be printed on a user's home computer printer. However, these printed documents suffer from all of the limitations described above with respect to loose sheets of paper that are, typically, not designed for high-quality images. Moreover, PDF documents offered by various web sites usually provide content in conjunction with a web site, rather than providing content that is displayed in the web site. For example, technical manuals and journals, white papers and sales brochures comprise typical PDF documents that are available on Internet web sites. One skilled in the art will recognize that it is possible to produce a PDF document comprising content in a web site. However, printing such a PDF results in many if not all of the same problems identified above.

In summary, therefore, a “web page” that is printed, for example, by using native web browser functionality, is not a “formatted print page.” A collection or a series of typical web pages do not naturally or logically easily translate to a correct sequence of printed pages as they appear in a typical publication, such as in a book or a magazine. As used herein, “formatted print pages” refer, generally, to pages that comprise text, graphics and/or images that are printed on a particular paper size, in a particular format and layout, using specific colors or print technology with sequential print pages that can be placed on the same side of sequential printed pages or in a double-sided arrangement. Typically, the resolution of formatted print pages is 70 times higher than that displayed in typical web pages. As used herein, the term “formatted print pages” refers, generally, to printed content, at least some of which is identified in an Internet web site and is printed including characteristics, as described herein. Formatted print pages have a much more attractive, professional form and appearance over prior art forms, substantially as described above. Furthermore, a typical web page can be designed in practically unlimited width and length. Typical web browser software provides horizontal and vertical scroll bars automatically while displaying a web site that extend horizontally and/or vertically beyond the viewable region of a display screen. These, and other known variables affecting the layout of a web page, contribute to fundamental differences between a web page and a formatted print page.

Also as used herein, formatted print pages refer to printed pages that meet at least some criteria set forth above, such that the web site content can be utilized by a printing company or other production entity such as in-house corporate printing facilities to create print media, including web site content that is combinable or that can be bound into a book, a magazine or the like.

A drawback of the prior art ensues from the fact that users cannot obtain printed web pages that are bound in a book-like or magazine-like fashion. Web sites may purport to provide a user with a printable version of web pages (so-called “printer friendly” versions), but do so without any specific knowledge of the printing equipment on which such pages are to be printed, resulting in all of the foregoing drawbacks of the prior art. In other words, a web host provides web pages without any ability and without including any special software that assures that the user will obtain a pre-defined page layout and sequencing that will be standardized to the particular web pages being displayed.

Many kinds of systems exist for binding sheets of paper, such as hard or soft-cover loose-leaf binders and plastic binding strips that are slid along the left margin of a set of pages, staples and the like. However, these systems are never as satisfactory as saddle-stitched or perfect bound books or magazines for several reasons. For example, the holes necessary to place pages into loose-leaf binders may overlay text or an image of the page. Also, loose-leaf binders are often bulky and do not file well on bookshelves since they are usually not rectangular, but triangular solids. Furthermore, binding strips often obscure parts of the text or image area of the pages and make the resulting collection of papers impossible to lay flat on a horizontal surface, such as a desk.

Stapling materials also results in similar defects as described above with respect to binding strips. Stapling usually works well only with a relatively small number of pages, unless a heavy-duty stapler (not usually an item of home use) is used. Stapling also often damages pages, which are then prone to tearing.

Referring to the drawings in which like reference designators refer to like elements, FIG. 1 shows a prior art hardware arrangement for viewing, reviewing and outputting internet web site content. As shown in FIG. 1, an information processor with web server 2 provides electronic content to a user terminal 4 that communicates with the information processor 2 via communication network 16. The user terminal preferably employs software that enables a communication session to be established between the user terminal 4 and the information processor with web server 2. Preferably, the information processor 2 employs software enabling a communication session, for example an HTTP session, to be established between the user terminal 4 and the web server 2. Information processor 2 typically provides content over the Internet which can be received by user terminal 4. Content includes, for example, text, graphics, pictorial, audio and video material.

Also as shown in FIG. 1, an output printer 7 is preferably controlled by user terminal 4 to provide printed output of content. For example, after a person views content on user terminal 4 using typical web browser software, the person selects an option to print the content on printer 7. The printed version, unfortunately, is typically unsatisfactory for the reasons set forth above.

There is a need in the industry to provide printed versions of web site content, as a whole or in part, as formatted print pages.

Inexpensive printers designed to be connected to individual personal computers or to computer networks such as a corporate network or intranet, and shared by several users of personal computers have proliferated. Such printers are often multifunction devices that incorporate other functions such as copying, scanning, faxing, etc. The devices typically use expendable resources such as ink or toner cartridges that have to be replaced frequently. These expendable materials are not inexpensive. Such printers are now typically capable of printing in color, the ink or toner cartridges for which is even more expensive.

The easy availability and proliferation of such printers is coupled with a number of trends that makes printing more tempting, such as: the virtually unlimited availability of printable materials on the World Wide Web; the trend to distribute documentation (such as for computer hardware and software) only in electronic form, even when the product is distributed in a physical medium such as a CD; the increasing distribution of computer software products via the World Wide Web, which makes the distribution of printed documentation impractical; and the use of email to distribute documents in electronic form.

The result of these trends is that individuals, particularly in offices, are printing more and more pages, and often in color. As a result, organizations are spending a considerable amount of money on ink and toner cartridges, usually without any control over such expenses.

There is thus a need in the industry to provide controls over corporate printing resources. The technical problem associated this need is how to route, through the various hardware resources of the organization, the print information to the printer that is most appropriate for the type of information that is to be printed. This poses a further technical problem of identifying the characteristics of the information to be printed in order to determine the appropriate hardware device, i.e., printer, on which the information should be printed.

### SUMMARY OF THE INVENTION

The present invention solves many of the above-described problems by enabling corporate Information Technology (IT) departments or other supervisory authorities to automatically or semi-automatically control the printing of materials that consume expensive expendable resources.

The present invention is directed to a method for providing printed pages of information in response to an electronic request received over a communication network. The method includes providing software program that is installed on an individual's personal computer or workstation, on any computer on a network, on a printer server, or on the computer controlling a printer. The software program intercepts print requests directed to the individual's personal printer, to any printer attached to the network, to the printer controlled by the particular computer, or to any set of user-specified printers.

Based on default or user-specifiable criteria, the software program evaluates the file representing the document to be printed and determines whether the document is allowed to be printed by the originally intended printer or whether it is redirected to a central site, as described herein. The software further determines whether the document is to be printed double-sided on double-sized paper, produced in magazine-like format.

If the print request is to be redirected, the software sends the file representing document and appropriate information allowing the request to be fulfilled to a central site via the Internet, corporate intranet or equivalent network.

Optionally but preferably, if the print request has been so redirected, the software displays a notification to the individual to this effect.

The present invention is further directed to a system for providing formatted print pages that comprise content represented in a web site. The system comprises add-in software operable with the web site that enables a visitor of the web site to submit an electronic request for the formatted print pages. The system includes a request receiving module that receives the electronic request over a communication network, and a request processing module that processes the contents of the electronic request and provides electronic production information that provides instructions for fulfilling the electronic request. The system also includes a transmitting module that transmits the electronic production information to a fulfillment facility operable to provide the formatted print pages corresponding with the electronic production information, and a formatted print pages delivery module operable to provide to the visitor the formatted print pages.

Other features and advantages of the present invention will become apparent from the following description of the invention which refers to the accompanying drawings.

### BRIEF DESCRIPTION OF THE DRAWINGS

For the purposes of illustrating the invention, there is shown in the drawings a form which is presently preferred, it being understood, however, that the invention is not limited to the precise arrangements and instrumentalities shown. The features and advantages of the present invention will become apparent from the following description of the invention that refers to the accompanying drawings, in which:

FIG. 1 shows a prior art hardware arrangement for viewing, reviewing and outputting internet web site content;

FIG. 2 shows an example hardware arrangement of a preferred embodiment of the present invention;

FIG. 3 is a block diagram illustrating the functional elements in an example information processor;

FIG. 4 is a flowchart illustrating the method of the present invention.

### DETAILED DESCRIPTION OF THE INVENTION

The present invention enables an organization, such as a corporation, to control the printing of expensive print jobs. As described above, the control of these print jobs is becoming increasingly important as more and more users are printing the content of web sites, which typically involve color and graphics. These web site elements consume expendable print resources, such as color ink and toner, at historical levels. The web sites can either be internal on an intranet or external on the Internet. The present invention enables a visitor of a web site to receive at least some content displayed in the web site as formatted print page(s). As used herein, the terms “visitor” and/or “visitor terminal” refer, generally, to a person and/or device operated by a person that establishes a communication session over a network with another device.

More particularly, an on-line service provider, operating an information processor and referred to herein, generally, as a “production information processor,” preferably provides software for proprietors of web sites who are desirous to provide formatted print pages of content displayed in their web sites, or content related thereto. Similarly, the production information processor can be hosted internally on a corporation's intranet. In addition to providing the services for creating formatted print pages, the internal production information processor can also be used to control the printing of expensive print job on the corporation's printers. The source of the information contained in the print jobs can either be from the external Internet or from the internal intranet. The production information processor can be used to provide only the control of the print jobs, or only for the creation of the formatted print pages or for both.

In a preferred embodiment, software incorporating the present invention is incorporated into a web site, either internal or external, referred to herein as a “information content web site” A visitor to the information content web site can request at least a portion of the web site to be reproduced as one or more formatted print page(s). The production information processor preferably uses information received in a request to provide formatted print pages. The production information processor contributes to the production of the formatted print pages in accordance with predetermined styles and layouts.

The software provided by the production information processor (hereinafter, the “add-in software”) is used in connection with one or more software programs that generate an information content web site. The add-in software preferably allows visitors to the information content web site to order formatted print pages comprising the content provided in or related to the information content web site. The add-in software functions to transmit information about an order for formatted print pages to one or more production information processor.

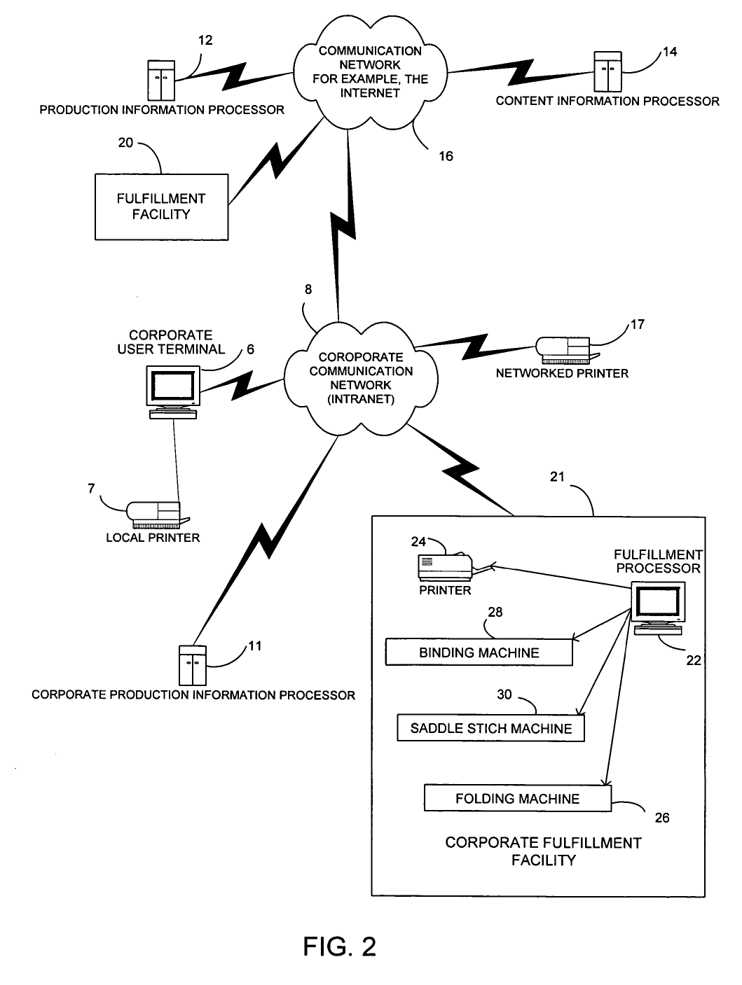

FIG. 2 shows an example of a preferred embodiment of the present invention, including a hardware arrangement of system 10 for controlling user requested print jobs and for providing formatted print pages comprising web site content. System 10 comprises at least one production information processor 12 coupled to a publicly available communication network 16, such as the Internet 16. System 10 further includes at least one corporate production information processor 13 coupled to a corporate network 15, an intranet. At least one information content processor 14 is coupled to communication network 16. The content information processor 14 preferably provides an Internet web site 15 that includes content for visitors.

Also as shown in FIG. 2, a fulfillment facility 20 communicates with at least the production information processor 12 and receives instructions with respect to a request for formatted print pages. Although the embodiment shown in FIG. 2 identifies the fulfillment facility 20 separate from the production information processor 12, the fulfillment facility 20 can be under the direct control of the proprietor of the production information processor 12. All of the elements described below (22, 24, 28, 30 and 26) that are contained in corporate fulfillment facility 21 are also preferably contained in fulfillment facility 20. The functions of these elements are the same in fulfillment facility 20 as they are in corporate fulfillment facility 21 as these two facilities are substantially identical, one being hosted and maintained with the organization, 21, and one being a vendor operated, external, commercial facility, 20.

In the example shown in FIG. 2, corporate fulfillment facility 21 preferably includes a formatted print page output printer 24. In addition to the formatted print page output printer 24, one or more other devices are preferably provided and used in accordance with the present invention. For example, corporate fulfillment facility 21 employs a binding machine 28 to combine individual sheets. Further, a saddle stitch machine 30 may be included to provide a professional appearance for the printed output. Further, a folding machine 26 may be employed by the fulfillment facility 20 in order to prepare signatures, i.e., sets of one or more sheets for binding. As shown in FIG. 2, the output related devices, including, the folding machine 26, binding machine 28, and saddle stitch machine 30 are presented as separate and apart from the formatted print page output printer 24. Of course, one skilled in the art will recognize that two or more of these devices may be integrated into a single device. For example, the formatted print page output printer 24 may have a series of attachments that comprise a folding machine and a binding machine. The folding machine and binding machine can operate to produce one or more signatures.

The corporate fulfillment facility 21 is coupled to the corporate network 8. Corporate fulfillment facility is used to support the special printing needs of the corporate users 6. In addition to the local printer 7 attached to a corporate user's workstation 6, and the printing devices included in the corporate fulfillment facility 16, a plurality of other network printers 17 are attached to the corporate network 8. The user 6 has preferably has access and rights to print to one or more of these network printers 17.

Production information processors 11 and 12 preferably includes all databases necessary to support the formatted print pages functions of the present invention. However, it is contemplated that production information processors 11 and 12 can access any required database via communication networks 8 or 16 or any other communication network to which production information processors 11 and 12 may be coupled. Communication network 16 is preferably a global public communication network such as the Internet, but can also be a wide area network (WAN), local area network (LAN), or other network that enables two or more computers to communicate with each other.

In the preferred embodiment, production information processors 11 and 12 and content information processor 14 are any devices that are capable of sending and receiving data across communication networks 8 and 16, e.g., mainframe computers, mini computers, personal computers, laptop computers, a personal digital assistants (PDA) and Internet access devices such as Web TV. In addition, production information processors 11 and 12 and content information processor 14 are preferably equipped with a web browser, such as MICROSOFT INTERNET EXPLORER, NETSCAPE NAVIGATOR and the like. Production information processors 11 and 12 and content information processor 14 are coupled to communication networks 8 and 16 using any known data communication networking technology.

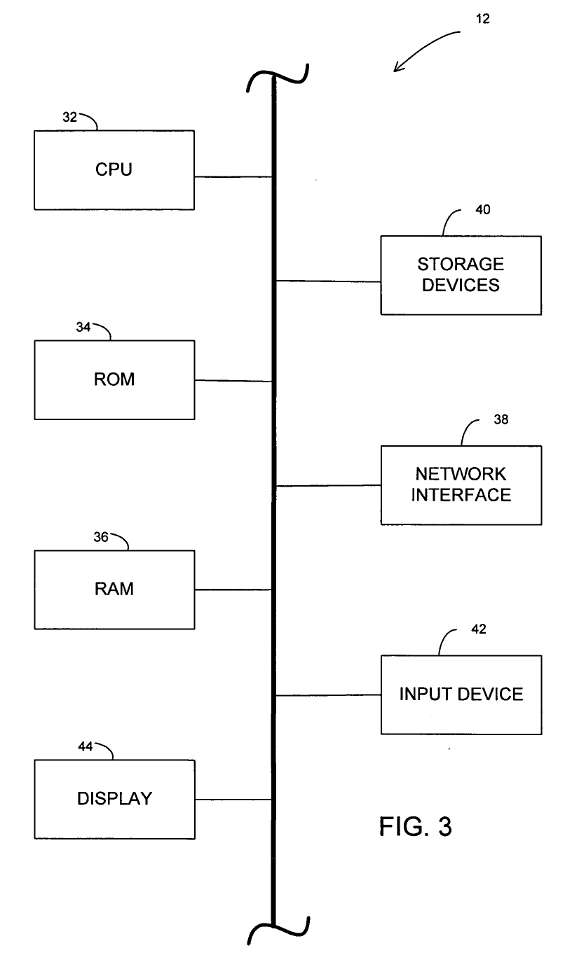

As shown in FIG. 3, the functional elements of a typical production information processors 11 and 12 are shown, and include one or more central processing units (CPU) 32 used to execute software code and control the operation of production information processors 1 and 12, read-only memory (ROM) 34, random access memory (RAM) 36, one or more network interfaces 38 to transmit and receive data to and from other computing devices across a communication network, storage devices 40 such as a hard disk drive, floppy disk drive, tape drive, CD ROM or DVD for storing program code databases and application data, one or more input devices 42 such as a keyboard, mouse, track ball, microphone and the like, and a display 44.

The various components of production information processors 11 and 12 need not be physically contained within the same chassis or even located in a single location. For example, storage device 40 may be located at a site which is remote from the remaining elements of production information processor 12, and may even be connected to CPU 32 across communication network 16 via network interface 38. Production information processors 11 and 12 preferably includes a memory equipped with sufficient storage to provide the necessary databases, forums, and other community services as well as acting as a web server for communicating hypertext markup language (HTML), Java applets, Active-X control programs or the like to content information processors 14. Production information processors 11 and 12 are arranged with components, for example, those shown in FIG. 3, suitable for the expected operating environment of production information processors 11 and 12. The CPU(S) 32, network interface(s) 38 and memory and storage devices are selected to ensure that capacities are arranged to accommodate expected demand.

As used herein, the terms “link” and “hyperlink” refer to a selectable connection from one or more words, pictures or other information objects to others in which the selectable connection is presented within the web browser. The information object can include sound and/or motion video. Selection is typically made by “clicking” on the link using an input device such as a mouse, track ball, touch screen and the like. Of course, one of ordinary skill in the art will appreciate that any method by which an object presented on the screen can be selected is sufficient.

The functional elements of production information processors 11 and 12 shown in FIG. 3 are of the same categories of functional elements present in content information processors 14, corporate user workstation 6 and fulfillment facility processor 22. However, not all elements need be present in the content information processor 14, corporate user workstation 6 or fulfillment facility processor 22. For example, storage devices, in the case of PDA's, and the capacities of the various elements are arranged to accommodate the expected user demand. For example, CPU 32 in content information processor 14 may be a smaller capacity CPU than the CPU present in the production information processors 11 and 12. Similarly, it is likely that the production information processors 11 and 12 will include storage devices of a much higher capacity than storage devices present in content information processor 14. Of course, one of ordinary skill in the art will understand that the capabilities of the functional elements can be adjusted as needed.

The nature of the invention is such that one skilled in the art of writing computer executable code (i.e., software) can implement the functions described herein using one or more of a combination of popular computer programming languages and developing environments including, but not limited to, C, C++, Visual Basic, JAVA, HTML, XML, ACTIVE SERVER PAGES, JAVA server pages, servlets, and a plurality web site development applications.

Although portions of the present invention are described by way of example herein and in terms of a web-based system using web browsers and a web site server, system 10 is not limited to such a configuration. It is contemplated that system 10 is arranged such that content information processor 14 communicates with and displays data received from production information processor 12 using any known communication and display method, for example, using a non-Internet browser WINDOWS viewer coupled with a local area network protocol such as the Internet Packet Exchange (IPX), dial-up, third-party, private network or a value added network (VAN).

It is further contemplated that any suitable operating system can be used on production information processors 11 12 and content information processor 14, for example, DOS, WINDOWS 3.x, WINDOWS 95, WINDOWS 98, WINDOWS NT, WINDOWS 2000, WINDOWS ME, WINDOWS CE, WINDOWS POCKET PC, WINDOWS XP, MAC OS, UNIX, LINUX, PALM OS, POCKET PC and any other suitable operating system.

As used herein, references to displaying data on production information processors 11 and 12 and content information processor 14 regard the process of communicating data across communication network 16 and processing the data such that the data is viewed on a corporate user workstation 6, for example by using a web browser and the like. As is common with web browsing software, the corporate user workstation 6 is capable of presenting sites within the system 10 such that a user can proceed from site to site within the system by selecting a desired link.

Therefore, each user's experience with system 10 is based on the order with which he/she progresses through the display screens. Graphic controls are preferably available in the display screens and modules to initiate data processes, and to provide convenient navigation between the display screens and modules of system 10. In other words, because the system is not completely hierarchical in its arrangement of display screens, users can proceed from area to area without the need to “backtrack” through a series of display screens. For that reason, and unless explicitly stated otherwise, the following discussion is not intended to represent any sequential operation steps, but rather to illustrate the components of system 10.

As used herein, the term “proprietor” refers, generally, to an owner/operator of a device, such as an information processor 12 or content information processor 14. A proprietor does not have to be in physical proximity with the device in order to exercise control over it. Also as used herein, a proprietor refers to a party who exercises control over the content and features provided on a web site and/or information processor.

As noted above, production information processor 12 preferably provides a production web site to which visitors can connect. Production web site is available to anyone who is able to establish a communication session with the production information processor 12. Once the session is established, the visitor can view content regarding services provided by the production information processor 12. Such content is considered herein, generally, as “public” content because access thereto is unrestricted. Production web site preferably also includes content which is restricted to authorized personnel, for example, registered customers who have contracted for the services provided by the proprietor of the production web site 13. Such content is referred to herein, generally, as “private” content. In one embodiment of the present invention, production information processor 12 provides corporate users (for example using corporate user terminal 6) with access to specialized services contracted for and customized to the user's corporation. As further describes below, this functionality allows the corporation to control print jobs requested from corporate user workstation 6 and therefore control costs.

The methods and processes by which a corporate user, using a corporate user terminal 6 can view order and print formatted print pages from content information processor 14, production information processor 12, corporate production information processor 11, corporate fulfillment facility 21 and fulfillment facility 20 is fully described in co-pending application Ser. No. 10/671,194 and shall not be reiterated herein.

The system and process for allowing organizational control of print job will now be described. As discussed above, organizations, typically corporations, are in need of some system and process for controlling the printing of materials by their employees. Although the proliferation of electronic communication was predicted to usher in a “paperless” society, the exact opposite has proven to be the case. Organizations are printing more paper copies of information than ever before. The costs associated with this printing are ever increasing and are proving difficult to control and manage. The system and method of the present invention provides the required control and management.

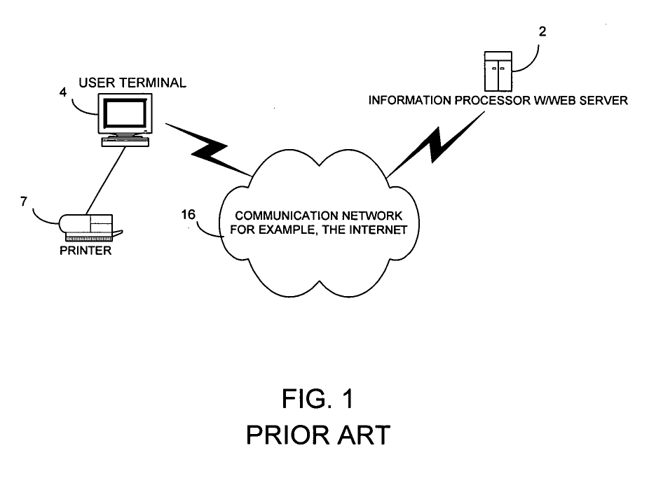

Returning to FIG. 1 for the moment, a software programs in accordance with the present invention are installed on an individual's personal computer or workstation 6, on selected computers (e.g., servers, not shown) on the corporate network 8, and on a printer server or other computer controlling a printer (e.g., networked printer 17). These software programs are the primary means by which the present invention is capable of controlling printing job within the organization.

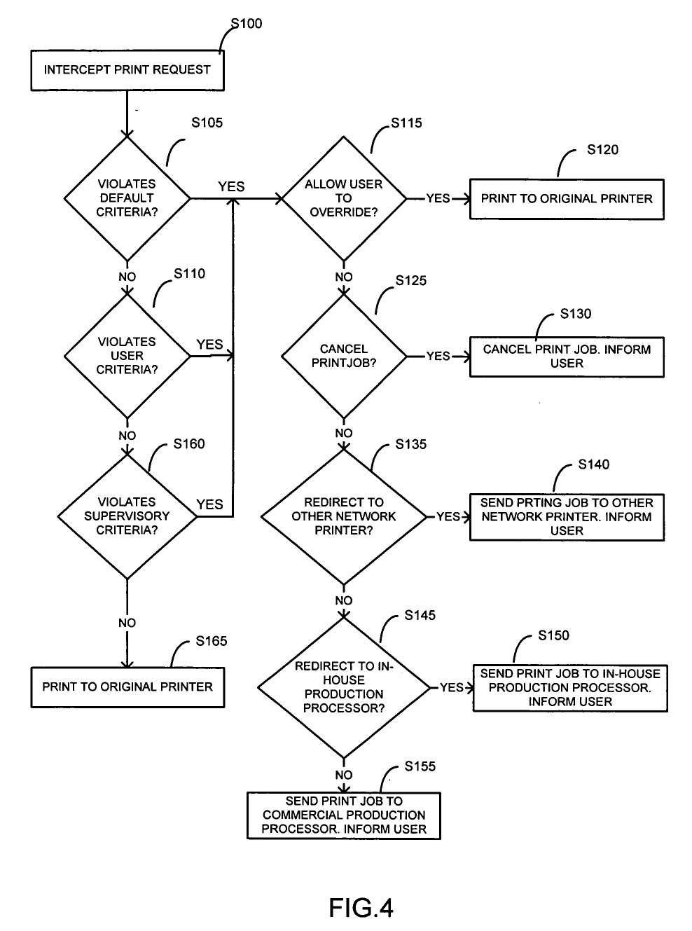

The flowchart illustrated in FIG. 4 illustrates the process by which print jobs are controlled. At a first level, at step S100, the software installed on a user's computer 8 intercepts the user's print requests (i.e., print job). One skilled in the art understands the mechanisms and routines for intercepting such a print request. The user's print requests can directed to the individual's personal printer 7 (FIG. 1), to any printer attached to the network (e.g., networked printer 17), to an in-house print facility (e.g., corporate production information processor 11 and corporate fulfillment facility 16, FIG. 1), or to a commercial printing facility (e.g., production information processor 11 and fulfillment facility 20).

The software installed on a user's computer 8 evaluates the requested print job based on one or more predefined criteria (described below). At the level of the user's workstation 8, the criteria can be a combination of default criteria set by the network administrator and criteria set by the user herself. Based on the default or user-specifiable criteria, the software program evaluates the file representing the information to be printed and determines whether the document is to be allowed to be printed by the originally intended printer, cancelled, redirected to a different network printer (e.g., networked printer 17), redirected to (e.g., corporate production information processor 11 and corporate fulfillment facility 16, FIG. 1), or to a commercial printing facility (e.g., production information processor 11 and fulfillment facility 20). As described in co-pending application Ser. No. 10/671,194, the in house (11, 16, FIG. 1) or commercial (12, 20, FIG. 1) printing facilities are capable of printing double-sided on double-sized paper, produced in magazine-like format.

One the technical solutions to the problems described above is the evaluation of the information to be printed in order to determine the most appropriate printer or printers on which the information should be printed. Optionally but preferably, when determining if the requested print job satisfies or violates the default or user specified criteria, the software examines the file representing the information to be printed to determine characteristics such as: file size; number of graphic elements in the file; total size of the graphic elements; number of pages; amount of color to be printed; and special characteristics of the document, such as pages with bleed. It is appreciated that the above list of characteristics is merely exemplary and that the system of the present invention is capable of evaluating any number of characteristics with respect to information to be printed. Furthermore, when evaluating whether to allow a print job to proceed to the originally directed printed, the system can further take into account other, external factors such as network load and printer availability.

The default and user specified criteria can define limits on the above described file characteristics or other factors. For example, a default criteria can be that no print job is allowed to a local printed that exceeds 100 pages. A user specified criteria and be not to allow printing of any file that contains graphics (due to cost and speed constraints. As is appreciated, the system and method of the present invention allows customization such that virtually any criteria can be established to control and management of printing resources within and organization. One of the more significant factors are print jobs that require color printing. The cost of ink to produce printed color documents is ever increasing and is becoming a significant cost component of any organization's printing budget.

If the print request violates either the default criteria (step S105) or the user specified criteria (step S110), further can be taken with respect to the print request. In one embodiment of the present invention, the user is able to override the criteria on a job by job basis (step S115). In this embodiment, a message is sent to the user, e.g., via email, informing her that the requested print job violated one or more of the default and or user specified criteria. In a preferred embodiment, the notification to the user of an impending re-direction of her print job is displayed to the user in a pop-up window on her workstation 6. This notification is in real time or near real time. In one embodiment, the user is prevented from taking any further action on her workstation 6 until she responds to the pop-up window. Whether via pop-up window or via email, the user is notified of the pending re-direction and is given the option to override the criteria and print the job to the originally intended printer (step S120). Optionally, the user's decision to override the criteria and print the job anyway is forwarded to a system administrator and/or management. The forwarding of this decision can be accompanied by the relative cost of the print job as is further described below.

If the user decides not to override the criteria that is preventing the job from being printed on the originally intended printer, or if the system has been set up to not allow the user to override the criteria, the process moves to step S125. Again, in a preferred embodiment, the user is notified of the impending re-direction of her print job via a pop-up window on her workstation 6. In step S125 it is decided if the print job should be cancelled. The cancellation of the job can either be automatic or the user can be given the option of canceling the job. If it is decided that the print request be cancelled, the print job is cancelled in step S130.

If it is decided that the print job is not to be cancelled, it is then determined whether the print job should be redirected to another printer. In step S135, it is determined if the print job should be redirected to another printer (e.g. 17, FIG. 1) on the network (8, FIG. 1). This action might be taken, for example, if the file is strictly a text file in back and white, and the user originally requested that the document be printed on a color printer. If it is determined that the print job should be re-directed, this is accomplished in step S140. Optionally but preferably, if the print request has been so redirected, the software displays a notification to the individual to this effect. Clearly, if the user's request has gone to another location, there are situations where the user should be so informed so that she can pick up her document at the correct printer. Also optionally, the system and method of the present invention provides the user with a interface informing her of the impending re-direction of her print job. This interface can optionally allow the user to pick another printer to which the job will be redirected. The list of available printers from which the user can choose is determined by the system, preferably based on the criteria that caused the original re-direction.

If the print job is not to be re-directed to another network printer, a determination is made in step S145 whether the print job is to be re-directed to an in-house printing facility (elements 11 and 16, FIG. 1). As described above and in co-pending application Ser. No. 10/671,194, the corporate production information processor 11 and corporate fulfillment facility 16 are capable of generating professional quality print materials such as saddle stitched or perfect bound output.

A further technical problem occurs when a printing job, intended for the kind of printer 7 typically attached to a local computer 6 or to a network printer 17, is redirected to the in-house printing facility, elements 11 and 16 (all in FIG. 1). Typically, the print job has to be reprocessed so that it will print properly on the device to which it is being redirected. This reprocessing is accomplished by processor 22 in corporate production information processor 11. Since the print job that is intercepted can be at a fairly low level (essentially instructions to a particular printing device), the software in processor 22 preferably includes the logic to determine where the page breaks exist in the original information so that processor 22 can reorder the pages. This is a technical problem in order to insure that the pages will be printed in the correct order when they're printed two-up, double-sided, and bound and folded. As described above, this technical process is known as imposition. In the preferred embodiment of the present invention, the imposition process is performed automatically.

If the organization does not have an in-house printing facility (elements 11 and 16, FIG. 1), the print request can be sent to a commercial printing facility (elements 12 and 14, FIG. 1) as described above and in co-pending application Ser. No. 10/671,194. This is illustrated in step S155. In both the case of the in house and the commercial printing facilities the print request along with control information, is preferably transmitted to the appropriate facility along with the formatted print pages. The control information preferably includes the name, mailing or shipping address, and mailing or shipping specifications and the email or other electronic address of the corporate user requesting the print job. Other information may be provided, as necessary and appropriate, including information about the fulfillment facility 20 providing printing services for all or selected formatted print pages printed by the entity and the like.

Preferably, an email or other electronic acknowledgment indicating receipt of an order for formatted print pages is transmitted from the production information processor 11 or 12 to the person placing the order, for example, upon a receipt and when the formatted print pages are prepared.

Returning to FIG. 4, the system and method of the present invention, optionally but preferably, provides an interface to an individual with supervisory authority who can set criteria for the redirection of print requests based on criteria such as the characteristics of the document or the file (as illustrated above), the authority of the individual making the request, the level of such print requests in a previous period (such as monthly, annually, year-to-date, etc.). See step S160. The supervisor has the capability to set and adjust the default criteria on the user's workstation (8, FIG. 1). Additionally, the supervisor specific criteria, preferably running on a server on the network, can be run automatically or require a human operator to deny or authorize print requests.

A unique and optional feature of the system and method of the present invention is the ability to calculate the cost of a requested print job. The software performing this calculation does so on the basis of the file characteristics of the print job as described above, as well as in view of the knowledge that the software has incorporated therein with respect to the operation of the various printers and print facilities available to network users. The software further has the capability to warn the user that a print request is expensive, and to ask the user whether he or she wants to continue.

In one embodiment, the software of the present invention transmits the information regarding the estimated or calculated cost of a print job to another program within the organization (e.g., an accounting program), along with identifying information regarding the individual originating the request, for chargeback or other budgetary, accounting or financial purposes.

Other uses and products provided by the present invention will be apparent to those skilled in the art.

Although the present invention has been described in relation to particular embodiments thereof, many other variations and other uses will be apparent to those skilled in the art. It is preferred, therefore, that the present invention be limited not by the specific disclosure herein, but only by the gist and scope of the disclosure.

We claim:

1. A method for controlling printing of information comprising:
detecting a request for the printing of the information, the request identifying a device on which the information is to be printed;
intercepting the request;
evaluating the request against predetermined criteria; and
redirecting the request to a different device in response to the evaluation.

2. The method of claim 1, wherein the evaluation is a first evaluation and the predetermined criteria includes system default criteria.

3. The method of claim 2, further comprising a second evaluation against the predetermined criteria, wherein predetermined criteria includes user defined criteria.

4. The method of claim 3, further comprising a third evaluation by a supervisor.

5. The method of claim 2, further comprising a second evaluation by a supervisor.

6. The method of claim 1, further comprising:
overriding, by a user that generated the request, the redirection of the request; and
printing the information on the device identified in the request.

7. The method of claim 6, further comprising prior to the overriding, prompting the user as to whether the redirection should be overridden.

8. The method of claim 1, further comprising canceling the request in response to the evaluation.

9. The method of claim 8, further comprising informing a user that generated the request of the cancellation of the request.

10. The method of claim 9, further comprising allowing the user to override the cancellation.

11. The method of claim 1, wherein the predetermined criteria include one of file size, number of graphic elements in the file, total size of the graphic elements, number of pages, and amount of color to be printed.

12. The method of claim 1, wherein the predetermined criteria include one of the authority of a user making the request and a level of previously made print requests in a previous period.

13. The method of claim 1, further comprising determining an estimated cost of fulfilling the request.

14. The method of claim 13, further comprising advising a user that made the request of the estimated cost of the request.

15. The method of claim 13, further comprising:
storing the estimated cost of the request; and
forwarding the estimated cost to an accounting facility.

16. The method of claim 1, wherein the device is a first printer, the redirecting further comprising redirecting the request to different printer.

17. The method of claim 16, further comprising informing a user that made the request of the redirecting of the request to the different printer.

18. The method of claim 1, wherein the redirecting further comprises redirecting the request to printing facility capable of printing on double sided, double sized paper.

19. The method of claim 18, wherein the printing facility is located on a network of an organization to which a user that made the request belongs.

20. The method of claim 18, wherein the printing facility is located on the Internet.

21. The method of claim 18, further comprising formatting the information for printing by the printing facility.

22. The method of claim 21, wherein the formatting further comprises reordering pages of the information.

23. The method of claim 21, wherein the formatting is performed automatically.

24. A method for an organization to control the printing of information by users within the organization, the organization having at least one network to which at least one user terminal, at least one printer and at least one printing facility are attached, the printing facility having double sided printing capabilities, the method comprising:
the user terminal generating a request for printing information on the at least one printer;
detecting the request for the printing of the information;
intercepting the request before its execution;
determining if the request satisfies one or more predetermined criteria;
redirecting the request to printing facility; and
printing the information at the printing facility.
